(19) United States
(12) Patent Application Publication
(10) Pub. No.: US 2006/0070699 A1
(43) Pub. Date: Apr. 6, 2006

(54) Composite sheet with mirror finish

(75) Inventors: Darrell L. Sparks, Kennebunk, ME (US); Grant B. LaFontaine, Kenneburk, ME (US)

Correspondence Address: KLAUBER & JACKSON, 411 HACKENSACK AVENUE, HACKENSACK, NJ, 07601, US

(73) Assignee: CYRO Industries

(21) Appl. No.: 11/234,055

(22) Filed: Sep. 23, 2005

Related U.S. Application Data
(63) Continuation-in-part of application No. 10/302,754, filed on Nov. 22, 2002, now abandoned.

(51) Int. Cl. B32B 37/00

(52) U.S. Cl. 156/244.27; 156/278; 359/838

(57) ABSTRACT

A method for producing a polymer mirror by continuously manufacturing a polymeric substrate, applying a reflective layer or layers which may be a polymer whose surface has been metalized so as to make it reflective or a multi-layer film wherein the combined refractive indices of the layers give the quality of a mirror surface. An optional coating may be applied to a surface of the reflective layer to promote adhesion to the underlying substrate. A composite is formed by heat lamination using a calendar roll assembly to fuse the layers into a rigid final article having a reflective surface having the character of a silver mirror, a highly reflective mirror, or a colored mirror.

### FIELD OF THE INVENTION

The present invention relates to a method for producing a polymer-based mirror. More specifically, the invention relates to a method for producing either a high-reflectance mirror or a colored mirror by laminating a polymeric substrate with a reflective layer or a series of layers.

### BACKGROUND OF THE INVENTION

Most plastic (polymer based) mirrors are produced by vacuum metalization of a substrate polymer in vacuum chambers or by depositing metal from a solution or from vapor onto the polymer surface. These processes can be carried out either on a film or on more rigid sheet products. Polymers commonly mirrorized include polymethylmethacrylate (PMMA) and its copolymers, polycarbonate, polyethylene terephthalate (PET), polystyrene, cyclic olefin co-polymers (COC's) and polyethylene terephthalate glycol (PETG), and combinations of the foregoing.

A second commonly employed method for preparing polymer mirrors is by producing a film with multiple very thin layers which, when placed in proximity to one another, behave as a mirror owing to the combination of refractive indices.

Heat lamination is a well known technique by which a laminating film is fused to a polymeric substrate but had not heretofore been used in the production of polymeric mirrors. For example, published Ohanesian, International patent Application WO/01/19591 A1 and U.S. Pat. No. 6,364,989 teach a method and apparatus for applying a decorative laminating film to a polymeric substrate. A melted polymeric composition is forced through an extrusion die and is then laminated with a decorative film of 20 to 500 microns in thickness by applying pressure as the composition and laminating film, passes through rollers, causing the decorative film and polymeric composition to fuse. That is, Ohanesian teaches enhancing an extruded polymeric substrate with a decorative laminating film by applying the decorative laminating film to a continuously extruded molten polymeric substrate as it is formed and pressing the two together with calendar rolls to form a composite. Ohanesian does not teach or suggest a mirror.

Eshbach, U.S. Pat. No. 6,676,799 teaches a decorative laminate. As such, it is not critical that the reflection be specular and free from distortion as with the present invention. In fact, the goal of Eshbach is to create a finish similar to a typical metal surface. Quite to the contrary, when preparing a mirror laminate, it is necessary that the reflection must be specular and of low distortion. This presents additional problems and requires carefully adjusting parameter. There remains a significant need for providing a heat lamination process, henceforth used to fuse layers of polymer sheet/film, for the new use of producing a rigid polymer mirror.

### SUMMARY OF THE INVENTION

The present invention provides methods for applying heat lamination, which has henceforth been used to fuse layers of a polymer sheet or film to the new use of producing a rigid polymer mirror. The rigid polymer mirror may be in some instances a high-reflectance mirror, a colored mirror, or a substantially silver mirror.

In a first aspect the invention provides a method for producing a rigid high reflectance mirror by laminating a polymeric substrate with a high-reflectance film that has been metalized by deposition of metal from vapor or plasma. The method for producing a polymer-based mirror comprises:
(a) Extruding a polymeric substrate;
(b) Applying a reflective film to the polymeric substrate as said polymeric substrate is manufactured to form a composite; and
(c) Forming the composite by applying heat to about the melting temperature of the polymeric substrate and by applying pressure to produce a rigid final article having a reflective surface characterized by a mirror-like appearance.

The method may utilize a reflective film having a first side and a second side with the first side being vacuum metalized. The second side may have a coating that facilitates adhesion to a relatively hot acrylic applied thereon. In preferred embodiments, the reflective film has at least two layers such that when the two layers are placed in proximity to one another, the film has a substantially mirror-like reflective appearance. In some preferred embodiments, the reflective film is comprised of polyethylene terephthalate. In still further preferred embodiments, the reflective film is metalized by causing metal to be deposited onto a surface of the reflective film from a solution. The thickness of the film prior to any such metallization is normally from about 0.001 inch to about 0.007 inch, preferably about 0.001 inch to about 0.005 inch, and in some instances about 0.002 or about 0.003 inches. Moreover, in preferred instances, the film demonstrates a shrinkage of less than about 20%, preferably less than about 10%, more preferably less than about 5%, and especially preferably less than about 2% or even less than about 1% when exposed to high temperatures (e.g. greater than 100° C.) or when exposed to temperatures encountered during the course of the method of producing.

Likewise, in other preferred embodiments, the forming of the composite takes place at substantially the melting temperature of the polymeric substrate. In general, the forming of the composite takes place at a temperature below 100° C., preferably below 95° C., more preferably below 90° C., more preferably below 85° C., still more preferably below 82° C., and in some instances below about 80° C. In instances where polyethylene terephthalate (PET) is the polymeric substrate, the forming of the composite is generally performed between about 75° C. and 85° C., preferably between 79° C. and 82° C. The polymeric substrate to which the reflective film is applied may be any one of a number of possibilities, but may in some instances be selected from the group consisting of PMMA, polycarbonate, polyethylene terephthalate, and polystyrene. In yet other instances, the polymeric substrate is an acrylic polymer.

In some embodiments, the method further comprises the additional step of:

(d) applying to a surface of the reflective film, which is not in continuous contact with another of said layers, a primer capable of promoting adhesion to the polymeric substrate.

In a second aspect the invention provides a mirror produced by the method described herein, the method generally including laminating a polymeric substrate with a high-reflectance film that has been metalized by deposition of metal from vapor or plasma. In some embodiments, the mirror is a high-reflectance mirror. In other embodiments, the mirror is a colored mirror. In yet other embodiments, the mirror is a substantially silver mirror. In preferred embodiments, the mirror of the present invention is substantially specular and substantially free from distortion or demonstrates a relatively low distortion. The mirrors of the present invention are particularly useful in commercial displays as well as in other areas where breakage resistance is desirable. Moreover, the mirrors of the present invention provide the added advantage of light weight as compared to glass in addition to superior resistance to breakage.

### DETAILED DESCRIPTION OF THE INVENTION

Before the present methods are described it is to be understood that this invention is not limited to the particular methods, compositions and experiments described herein. Moreover, it is to be understood that the terminology used herein is for the purpose of describing particular embodiments only and is not intended to be limiting, as the scope of the present invention is to be defined only by the appended claims.

Definitions:

By “shrinkage” is meant decrease in width of film when the film is exposed to processing temperatures of the polymer melt inherent to the method described and claimed herein. In one embodiment, “shrinkage” may be described as decrease in width of the film when the film is exposed to high temperatures of, for example, greater than 100° C.).

By “specular” is meant capable of reflecting light like a mirror, having the qualities of a mirror and capable of providing an image of objects.

By “substantially free of distortion” or “low distortion” is meant that the likeness of the image reflected by the mirror is substantially identical to the naturally occurring image so reflected therein.

Polymeric substrates suitable for use in the invention include any polymeric material such as acrylic from which a sheet product may be produced by calendering, including, but not limited to the following:

amorphous acrylic resins (e.g. polymethylmethacrylate);

polyalkylene terephthalates (e.g polyethylene terephthalate, polybutylene

terephthalate, and poly-1,4-cyclohexanedimethylene terephthalate);

copolymers of polyalkylene terephthalate (e.g. copolymers of terephthalic acid or esters thereof with any of the following: i) napthalene dicarboxylic acid or esters thereof; ii) isophthalic acid or esters thereof; Iii) phthalic acid or esters thereof; iv) alkane glycols; v) cycloalkane glycols; vi) alkane dicarboxyl!c acids; and vii) cycloalkane dicarboxylic acids; polyethylene naphthalate (PEN) and isomers thereof; copolymers of polyethylene naphthalate (PEN) including those of the (2,6-, 1,4-, 1,5-, 2,7-, and/or 2,3-naphthalene dicarboxylic acids, or esters thereof, with any of the following: i) naphthalene dicarboxylic acid or esters thereof; ij) isophthalic acid or esters thereof; iii) phthalic acid or esters thereof; iv) alkane glycols: v) cycloalkane glycols; vi) alkane dicarboxylic acids; and vii), cycloalkane dicarboxylic acids; polycarbonate resins including acrylonitrile butadiene styrene resins, polystyrene, syndiotactic polystyrene, syndiotactic polyalpha-methyl styrene, syndiotactic polydichlorostyrene, copolymers and blends of the foregoing styrenes; styrene copolymers such as styrene butadiene copolymers and styrene acrylonitrile copolymers, 4.4I-dibenzoic acid and ethylene glycol; polyacrylates such as polybutylacrylate and polymethylacrylate; and

polyimides such as polyacrylic imides and polyether imides; substituted and unsubstituted vinyl polymers and their copolymers; and other polymers processed by calendering including polyvinylchloride (PVC) as well as blends of two or more of the foregoing polymers or copolymers.

In one embodiment of the invention, a film is first metalized and subsequently laminated by a calendering roll process to a molten polymeric substrate as the substrate is extruded. Films suitable for metalization include, but are not limited to, PMMA and its copolymers, polycarbonate, cyclic olefin co-polymers (COC's) PET, polystyrene, and polyethylene terephthalate glycol (PETG) as well as mixtures and combinations thereof. Metalization of the film is typically accomplished either by depositing from plasma or vapor sputtering, such techniques being well known in the art. Preferably the thickness of the film before metalization is from about 0.001 inch to about 0.005 inch. Selection of the film is critical to the success of the lamination. If the film has too much shrinkage, the smooth mirror surface becomes distorted and can take on a matte appearance. A film shrinkage of less than about 2% is optimal to maintain good mirror optics. (i.e. Impact modified PMMA which has been metalized via vacuum deposition produced a laminated product with a dull matte appearance while the original film demonstrated a bright, highly reflective mirror finish.) A dull matte finish results when the film width shrank approximately 20%. Trials with various PET based films have yielded similar results where shrinkage of the film when exposed to elevated temperatures (>100° C.) is less than 2%.

TABLE 1
Demonstrating Film Thickness and Shrinkage

| | Film | | |
|---|---|---|---|
| Film Resin | Thickness (mil) | Shrinkage % | Visual Result |
| Acrylic | 2 | 12 | Hazy metallic appearance |
| PET | 1 | 4 | Severe wrinkles |
| PET | 1 | 2 | Smooth application |
| PET | 1 | 0.7 | Smooth application |

In another embodiment of the invention, a reflective film composed of multiple very thin layers is provided. Because of the combined index of refraction and thicknesses, such a reflective film provides the appearance of a colored mirror and is bonded to the polymer substrate. In a particular embodiment, the reflective film may be composed of about 300 to about 400 layers and has a total thickness of about 0.001 inch to about 0.002 inch. Films greater than 0.002″ thickness tend to cause the extruded polymer sheet to develop unacceptable warpage, e.g. greater than about 0.4 or 0.5 inches per foot. The thickness of the substrate acrylic also influences the degree of warpage. A thicker substrate is less susceptible to the warping effect.

TABLE 2
Demonstrating Film and Sheet Thicknesses related to Warpage

| | Film | Sheet | |
|---|---|---|---|
| Film Type | Thickness (in) | Thickness (in) | Warpage (in/ft) |
| Polycarbonate | 0.007 | 0.080 | .75 |
| Polycarbonate | 0.007 | 0.118 | 0.9 |
| Polycarbonate | 0.007 | 0.177 | .4 |
| PET | 0.003 | 0.118 | .3 |
| PET | 0.0005 | 0.118 | 0 |
| PET | 0.001 | 0.118 | <0.1 |

To improve adhesion to the acrylic or polymeric substrate, the reflective film, whether metalized or not, may be treated with an adhesion promoting coating, heat-seal or a primer, to further ensure bonding to the substrate. The manufacturer typically does application of such a coating and its use is a known and accepted technique in lamination. However, when compatible polymer films are chosen for the substrate and the mirrorized film or colored film nearest the substrate, no adhesion promoter may be necessary or in some instances, only treatment of the film surface by corona discharge or plasma is required prior to lamination.

### DETAILED DESCRIPTION OF THE PREFERRED EMBODIMENTS

The following illustrative examples are presented to provide those of ordinary skill in the art with a complete disclosure and description of how to make and use some particular articles and methods of the invention.

### Example 1

A series of four films were applied to an acrylic sheet 2 mm in thickness by feeding the films over the second roll of a three or four roll calendar system into a bank of melt of polymethylmethacrylate. The bank of melt was adjacent to the roll over which the film was run. Optionally, the melt bank could be adjacent to the opposite roll, but better results are achieved if the bank of melt is adjacent to the roll over which the film is fed. Tension was applied to the film to remove and prevent the formation of wrinkles.

1. Mirrorized Film

A mirrorized polyethylene terephthalate type material which had a heat activated adhesive applied by the manufacturer over the mirrorized surface was provided as a film having a width of 24″. Excellent adhesion and optics were achieved. Some small dimples or point distortions were noted in the metalized film. Adjusting temperatures of the calendar rolls could eliminate these defects.

2. Treated Color Mirror

A film was provided that had been treated by a corona discharge system. The roll was 48″ wide. The film itself adheres to the sheet with no further treatment. Excellent optical appearance was achieved. Again, small dimples could be eliminated with adjustments to the calendar roll temperatures. Excessive calendar roll temperature was found to cause an unacceptable hazy appearance to develop.

3. Polymeric Mirror Film

Results similar to film number 2 above as describing the treated color mirror.

4. High Temperature Polymeric Mirror Film.

Results similar to film number 2 above as describing the treated color mirror. In all cases it is critical to find the optimum calendar roll temperatures and speeds to prevent the development of optical defects in the mirror lamination. It was found that with the treated Color Mirror in point 2 the first 2 calendar rolls had to be run between 79° C. and 82° C. to prevent the formation of large round distortions in the film. At temperatures above the 82° C. level these defects occurred with increasing frequency as the temperature increased (highest temperature tried was 90° C. on the second roll). The temperatures of the 3rd and 4th rolls were also critical to maintaining good appearance. If the fourth roll was maintained more than 2° C. hotter than the third roll the laminated film developed a very hazy appearance. The same could be caused by operating the 3^{rd} and 4^{th} rolls at surface speed difference greater than 1%.

What is claimed is:

1. A method for producing a polymer-based mirror comprising:
a. Extruding a polymeric substrate;
b. Applying a reflective film to said polymeric substrate as said polymeric substrate is manufactured to form a composite; and
c. Forming said composite by applying heat to about the melting temperature of the polymer and pressure to produce a rigid final article having a reflective surface characterized by a mirror-like appearance.

2. The method of claim 1 wherein the reflective film has a first side and a second side, said first side being vacuum metalized and said second side having a coating that facilitates adhesion to a hot acrylic applied thereon.

3. The method of claim 1 wherein the reflective film has at least two layers, wherein when said layers are placed in proximity to one another, said film has a mirror-like reflective appearance.

4. The method of claim 1 comprising the additional step of applying to a surface of said film which is not in continuous contact with another of said layers a primer capable of promoting adhesion to said polymeric substrate.

5. The method of claim 1 wherein the final article is a high-reflectance mirror.

6. The method of claim 1 wherein the final article is a colored mirror.

7. The method of claim 2 wherein the thickness of the reflective film prior to metallization is from 0.001 inch to about 0.007 inch.

8. The method of claim 2 wherein the thickness of the reflective film prior to metallization is from about 0.001 inch to about 0.005 inch.

9. The method of claim 2 wherein the thickness of the reflective film prior to metallization is from about 0.001 to about 0.003 inches.

10. The method of claim 2 wherein the thickness of the reflective film prior to metallization is from about 0.001 to about 0.002 inches.

11. The method of claim 1 wherein the reflective film demonstrates a shrinkage of less than about 20% during the method.

12. The method of claim 1 wherein the reflective film demonstrates a shrinkage of less than about 10% during the method.

13. The method of claim 1 wherein the reflective film demonstrates a shrinkage of less than about 5% during the method.

14. The method of claim 1 wherein the reflective film demonstrates a shrinkage of less than about 2% during the method.

15. The method of claim 1 wherein the reflective film demonstrates a shrinkage of less than about 1% during the method.

16. The method of claim 1 wherein the reflective film is selected from the group consisting of PMMA and its copolymers, polycarbonate, cyclic olefin co-polymers (COC's), polyethylene terephthalate (PET), polystyrene, and polyethylene terephthalate glycol (PETG) as well as mixtures and combinations thereof.

17. The method of claim 1 wherein the reflective film is comprised of polyethylene terephthalate (PET).

18. The method of claim 1 wherein the forming of the composite takes place at a temperature approximately equal to the melting temperature of the polymeric substrate.

19. The method of claim 1 wherein the reflective film has been metalized wherein metal is deposited onto a surface of said reflective film from a solution.

20. The method of claim 1 wherein the polymeric substrate is selected from the group consisting of PMMA, polycarbonate, polyethylene terephthalate (PET), and polysterene.

21. The method of claim 1 wherein the polymeric substrate is an acrylic polymer.

22. A mirror produced by the method of claim 1.

23. A mirror according to claim 22 wherein the mirror is a high-reflectance mirror.

24. A mirror according to claim 22 wherein the mirror is a colored mirror.

25. A mirror according to claim 22 wherein the mirror is a substantially silver mirror.

26. A method for producing a polymer mirror comprising the steps of:
(a) continuously manufacturing a polymeric substrate,
(b) applying one or more reflective layers having a metalized surface to the polymeric substrate;
(c) forming a composite by heat lamination to fuse the polymeric substrate and one or more reflective layers into a rigid final article having a reflective surface.

27. The method according to claim 26 wherein the combined refractive indices of the polymeric substrate and one or more reflective layers provide the quality of a mirror surface.

28. The method according to claim 26 further comprising the step of applying a coating to a surface of one or more reflective layers to facilitate adhesion of the one or more reflective layers and the polymeric substrate.

29. The method according to claim 26 wherein forming a composite by heat lamination to fuse the polymeric substrate and one or more reflective layers into a rigid final article having a reflective surface is performed using a calendar roll assembly.
